(19) United States
(12) Patent Application Publication
(10) Pub. No.: US 2005/0160857 A1
(43) Pub. Date: Jul. 28, 2005

(54) Worm wheel

(75) Inventor: Yoichi Takeuchi, Kawaguchi-shi (JP)

Correspondence Address: BACHMAN & LAPOINTE, P.C., 900 CHAPEL STREET, SUITE 1201, NEW HAVEN, CT, 06510, US

(73) Assignee: ENPLAS CORPORATION

(21) Appl. No.: 11/029,617

(22) Filed: Jan. 5, 2005

(30) Foreign Application Priority Data
Jan. 15, 2004 (JP) 2004-008558

(51) Int. Cl. F16H 1/16

(52) U.S. Cl. 74/425; 74/462

(57) ABSTRACT

In a worm wheel 1 having a plurality of teeth 2 on the outer periphery thereof for meshing with a worm, each of the teeth 2 is crowned from substantially central portions 2a toward both end portions 2b, 2c in facewidth directions to form non-contact portions, which do not contact the worm, in the substantially central portions 2a and both end portions 2b, 2c in facewidth directions. A lubricant is filled in the non-contact portions, which do not contact the worm and which are formed in and near the substantially central portion 2a in facewidth directions, to reduce frictional resistance during meshing.

### BACKGROUND OF THE INVENTION

1. Field of the Invention

The present invention relates to a worm wheel for use in power transmission devices for various automotive parts, industrial equipments, precision instruments and so forth.

2. Description of the Prior Art

In general, a typical worm gear 13 having a structure shown in FIG. 7 is used for transmitting power between two shafts, which are not parallel to each other and which do not cross each other, in a power transmission device, and for obtaining a very large reduction ratio. In such a worm gear 13, the meshing of a worm 14 with a worm wheel 15 is a line contact, and heat is generated by a friction resistance caused on the meshing surface, so that part of transmission energy is converted into thermal energy, thereby easily causing energy loss.

In recent years, some of worm gears are formed of a plastic in order to reduce operating noises. However, the drop in strength of plastics due to heat generation is greater than that of metals. Therefore, if a worm wheel of a worm gear is formed of a plastic, heat generated in the worm wheel itself as well as heat conducted from the worm gear is added to the worm wheel, so that there is a problem in that the high temperature rise of teeth of the worm wheel deteriorates the strength of the teeth and promotes early wear. In particular, the central portion of each of the teeth of the worm wheel in facewidth directions more easily holds heat than both end portions thereof in facewidth directions, so that heat generation greatly has a bad influence on the central portion.

In order to eliminate such a problem, it is effective to suppress heat transfer from the worm to the worm wheel by decreasing the frictional resistance on the meshing surface of the worm with the worm wheel and/or by decreasing the area of the meshing portion of the worm with the worm wheel. Therefore, for example, Japanese Patent Laid-Open No. 2003-207031 has proposed that heat generation due to frictional resistance is reduced by lubricating the meshing frictional surface with a lubricating oil filled in grooves which are formed in the tooth flanks of a worm meshing with a worm wheel so as to extend along tooth traces thereof. Also, Japanese Patent Laid-Open No. 60-227057 has proposed that the area of the meshing surface of a worm with a worm wheel is decreased by forming vertical grooves in the central portions of each of the teeth of the worm wheel.

However, in the technique proposed in Japanese Patent Laid-Open No. 2003-207031, it is not considered that heat transfer from the worm to the worm wheel is suppressed, so that the high temperature rise of the teeth of the worm wheel can not be sufficiently suppressed although the decrease of frictional resistance due to lubrication on the frictional surface can be expected.

As shown in FIG. 8, in the technique proposed in Japanese Patent Laid-Open No. 60-227057, recessed portions 17 formed in tooth flanks 16 during molding are allowed to be exposed the atmosphere via vertical grooves 18 during meshing, so as to prevent air and/or oil from being compressed and closed in the recessed portions 17 of the tooth flanks 16, thereby preventing noises from being caused by the instantaneous release of air and/or oil closed in the recessed portions 17. However, it is not designed to suppress heat generation on the meshing tooth flanks 16 and heat transfer from the worm 14 to the worm wheel 15.

### SUMMARY OF THE INVENTION

It is therefore an object of the present invention to eliminate the aforementioned problems and to provide a worm wheel capable of effectively preventing heat from being generated in the teeth thereof.

In order to accomplish the aforementioned and other objects, according to one aspect of the present invention, a worm wheel comprises: a worm wheel body having a plurality of teeth on an outer periphery thereof, for meshing with a worm; and heat insulating portions, formed in a substantially central portion and both end portions in facewidth directions of each of the plurality of teeth, for preventing heat from being transferred from the worm.

In this worm wheel, each of the insulating portions may be an air layer formed between a corresponding one of the plurality of teeth and the worm.

According to another aspect of the present invention, a worm wheel comprises: a worm wheel body having a plurality of teeth on an outer periphery thereof, for meshing with a worm; and non-contact portions which do not contact the worm, the non-contact portions being formed in a substantially central portion and both end portions in facewidth directions of each of the plurality of teeth, by crowning a corresponding one of the plurality of teeth from the substantially central portion toward the both end portions in facewidth directions.

In this worm wheel, the non-contact portions formed in the substantially central portion in facewidth directions may be filled with a lubricant.

In a worm wheel according to the present invention, since heat insulating portions are designed to insulate heat from a worm, it is possible to suppress the temperature rise of teeth due to heat from the worm, and it is possible to suppress wear and deterioration in the strength of teeth due to the temperature rise of the teeth, so that it is possible to precisely transmit power for a long period of time. Such effects are remarkably obtained when the worm wheel is formed of a plastic.

In a worm wheel according to the present invention, a lubricant is filled in a portion which is positioned in a substantially central portion in facewidth directions and which does not contact a worm, so that it is possible to supply the lubricant to a frictional contact portion with a worm to reduce a frictional resistance on the worm to reduce heat generation due to friction.

### BRIEF DESCRIPTION OF THE DRAWINGS

The present invention will be understood more fully from the detailed description given herebelow and from the accompanying drawings of the preferred embodiments of the invention. However, the drawings are not intended to imply limitation of the invention to a specific embodiment, but are for explanation and understanding only.

In the drawings:

FIG. 1 is a front view of a preferred embodiment of a worm wheel according to the present invention;

FIG. 2 is a longitudinal section of the worm wheel taken along line II-II of FIG. 1;

FIG. 3 is an enlarged perspective view of some of teeth of the worm wheel in the preferred embodiment;

FIG. 4 is an enlarged perspective view of some of teeth of a conventional worm wheel;

FIG. 5 is a plan view of a modified example of a tooth of the worm wheel in the preferred embodiment;

FIG. 6 is a longitudinal section of another modified example of a worm wheel in the preferred embodiment;

FIG. 7 is a schematic drawing of a typical worm gear, wherein the worm gear is partially cut to show a meshing state of a worm with a worm wheel; and

FIG. 8 is a perspective view of a tooth of a conventional worm wheel.

### DESCRIPTION OF THE PREFERRED EMBODIMENTS

Referring now to the accompanying drawings, the preferred embodiment of a worm wheel according to the present invention will be described below in detail.

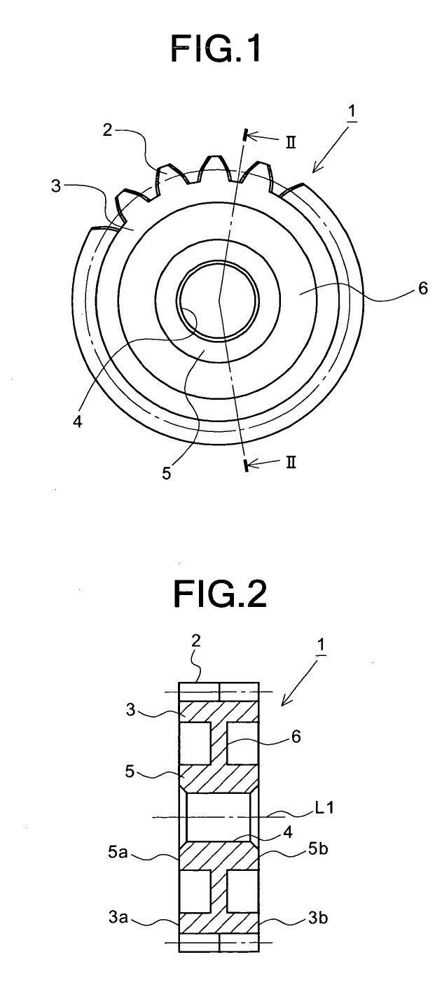

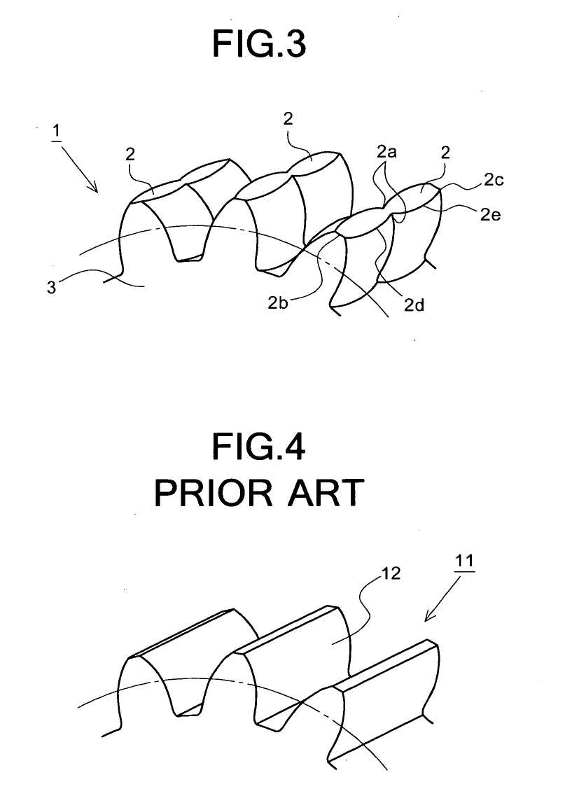

FIGS. 1 through 3 show a preferred embodiment of a worm wheel 1 according to the present invention. FIG. 1 is a front view of the worm wheel 1, and FIG. 2 is a longitudinal section of the worm wheel 1. FIG. 3 is a perspective view of some of teeth 2 of the worm wheel 1.

In these figures, the worm wheel 1 may be molded by injecting a resin material, such as polyacetal, polyamide, polyphenylene sulfide or polybutylene terephthalate, and comprises a rim 3 having teeth 2 on the outer periphery thereof, a substantially cylindrical hub (shaft supporting portion) 5 having an axial hole 4 at the center thereof, and a web 6 connecting the rim 3 to the hub 5 in radial directions. In this preferred embodiment, the length of the hub 5 in directions of an axis (L1) is equal to a facewidth of the worm wheel 1, so that both ends 5a and 5b of the hub 5 in axial directions are substantially formed on the same plane as that of both ends 3a and 3b of the rim 3 in facewidth directions. A substantially central portion of the rim 3 in facewidth directions and a substantially central portion of the hub 5 in axial directions are connected to each other in radial directions by means of the web 6.

As shown in FIG. 3, each of the teeth 2 is crowned from a substantially central portion 2a toward both end portions 2b and 2c in facewidth directions, respectively, so that the shape of each of the teeth 2 is symmetrical with respect to the central plane in facewidth directions. That is, the first crowning of each of the teeth 2 is carried out so that the tooth thickness of a substantially intermediate portion 2d between the substantially central portion 2a and one end portion 2b in facewidth directions is greater than the tooth thickness of the substantially central portion 2a and one end portion 2b in facewidth directions. In addition, the second crowning of each of the teeth 2 is carried out so that the tooth thickness of a substantially intermediate portion 2e between the substantially central portion 2a and the other end portion 2c in facewidth directions is greater than the tooth thickness of the substantially central portion 2a and the other end portion 2c in facewidth directions. Thus, the substantially central portion 2a and both end portions 2b, 2c in facewidth directions of each of the teeth 2 are non-contact portions which do not contact a worm (not shown) meshing with the worm wheel 1. Furthermore, although ridgelines appear on the boundary portion between the first crowing and second crowning in the figure, the boundary portion may be a smoothly curved portion without ridgelines.

Each of the teeth 2 thus formed by crowning from the substantially central portion 2a toward the both end portions 2b, 2c in facewidth directions is designed to form gaps (non-contact portions) in the substantially central portion 2a and the both end portions 2b, 2c in facewidth directions between the worm wheel and the worm, so that air in the gaps insulates heat from the worm. That is, each of the teeth 2 of the worm wheel 1 is designed to have heat insulating portions of air layers in and near the substantially central portion 2a and both end portions 2b, 2c in facewidth directions when the worm wheel 1 meshes with the worm.

If each of the teeth 2 is thus crowned so as to be symmetrical with respect to the substantially central portion 2a in facewidth directions, two maximum tooth thickness portions (the intermediate portions 2d, 2d) are formed so as to be symmetrical with respect to the substantially central portion 2a in facewidth directions, so that the maximum tooth thickness portions (2d, 2e) are designed to mesh with the worm.

According to this preferred embodiment with such a construction, heat generated during the transmission of power by meshing the worm wheel 1 with the worm is insulated by the air layers in the non-contact portions (2a, 2b, 2c) formed by crowning, and heat transfer from the worm to the worm wheel 1 is carried out in only the two contact portions (the intermediate portions 2d, 2e), so that it is possible to suppress the temperature rise of the teeth 2 of the worm wheel 1 due to heat transfer from the worm to the worm wheel 1. As a result, it is possible to effectively prevent the strength of the teeth 2 of the worm wheel 1 from being deteriorated by the temperature rise thereof, and it is possible to effectively prevent wear from increasing. Furthermore, the tooth thickness of each of teeth 12 of a conventional worm wheel 11 shown in FIG. 4 is constant in width directions, and the contact area thereof with a worm is far wider than that of the worm wheel 1 in this preferred embodiment, so that the amount of heat to be transferred from the worm is greater than that of the worm wheel 1 in this preferred embodiment.

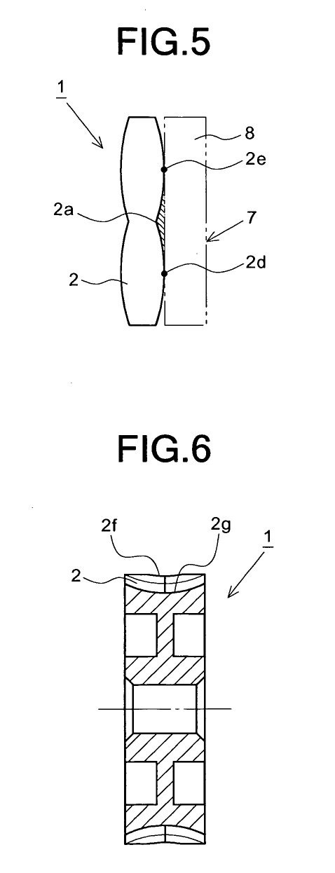

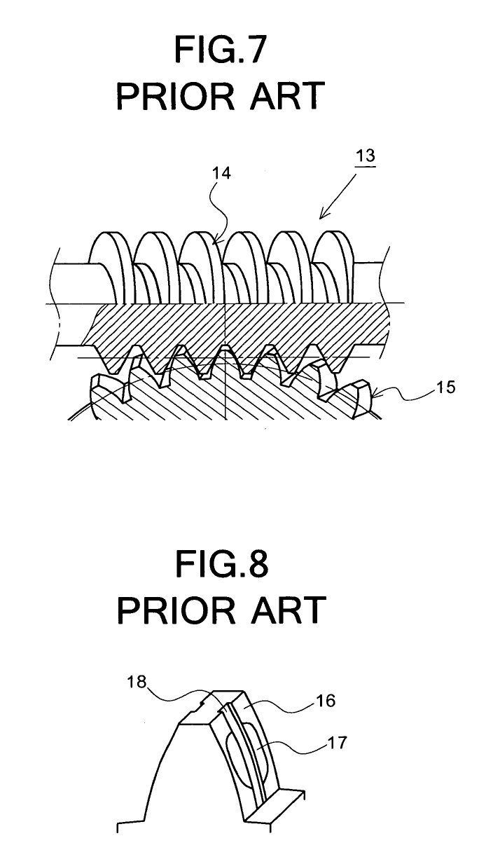

As shown in FIG. 5, in the worm wheel 1 in this preferred embodiment, portions (non-contact portions in the substantially central portion in facewidth directions as shown by slanting lines), which have a gradually decreasing tooth thickness between the maximum tooth thickness portions (the intermediate portions 2d, 2e) contacting teeth 8 of a worm 7, may be filled with a lubricant (e.g., grease) which lubricates the frictionally contacting portions (the intermediate portions 2d, 2e) of the teeth 2 to reduce the frictional resistance during meshing to prevent the temperature rise and wear due to friction on the tooth flank.

In the worm wheel 1 in this preferred embodiment, vertical grooves extending in tooth depth directions may be formed in the maximum tooth thickness portions (the intermediate portions 2d, 2e), which are contact portions with a worm and in which a lubricant is filled so as to lubricate the contact portions of the worm wheel with the worm. Thus, it is possible to effectively prevent heat from being generated by frictional resistance, so that it is possible to more effectively prevent the temperature rise of the teeth 2 in cooperation with the heat insulating effects of air layers in the heat insulating portions.

The worm wheel 1 in this preferred embodiment may be widely used as a worm wheel having teeth 2 extending in parallel to facewidth directions, a worm wheel having helical teeth 2, or an enveloping worm wheel wherein the bottom and tip are recessed so as to have a circular-arc shape in accordance with the shape of a worm as shown in FIG. 6.

A worm wheel according to the present invention can be effectively used when it is required to quietly and smoothly transmit power, and may be used with a worm for transmitting power between two shafts, which are not parallel to each other and which do not cross each other, at a very large reduction ratio.

While the present invention has been disclosed in terms of the preferred embodiment in order to facilitate better understanding thereof, it should be appreciated that the invention can be embodied in various ways without departing from the principle of the invention. Therefore, the invention should be understood to include all possible embodiments and modification to the shown embodiments which can be embodied without departing from the principle of the invention as set forth in the appended claims.

1. A worm wheel comprising:
a worm wheel body having a plurality of teeth on an outer periphery thereof, for meshing with a worm; and
heat insulating portions, formed in a substantially central portion and both end portions in facewidth directions of each of said plurality of teeth, for preventing heat from being transferred from said worm.

2. A worm wheel as set forth in claim 1, wherein each of said insulating portions is an air layer formed between a corresponding one of said plurality of teeth and said worm.

3. A worm wheel comprising:
a worm wheel body having a plurality of teeth on an outer periphery thereof, for meshing with a worm; and
non-contact portions which do not contact said worm, said non-contact portions being formed in a substantially central portion and both end portions in facewidth directions of each of said plurality of teeth, by crowning a corresponding one of said plurality of teeth from the substantially central portion toward said both end portions in facewidth directions.

4. A worm wheel as set forth in claim 3, wherein said non-contact portions formed in the substantially central portion in facewidth directions are filled with a lubricant.
